(19) United States
(12) Patent Application Publication
(10) Pub. No.: US 2003/0132299 A1
(43) Pub. Date: Jul. 17, 2003

(54) Communication terminal ,personal data transmitting system and method for transmitting data using the same

(76) Inventor: Soo- Won Rhee, Seoul (KR)

Correspondence Address: DANN DORFMAN HERRELL & SKILLMAN, SUITE 720, 1601 MARKET STREET, PHILADELPHIA, PA, 19103-2307, US

(21) Appl. No.: 10/275,637

(22) PCT Filed: Mar. 20, 2001
(86) PCT No.: PCT/KR01/00438

(30) Foreign Application Priority Data
May 8, 2000 (KR) 2000-24329

(51) Int. Cl. G06K 19/00

(52) U.S. Cl. 235/487

(57) ABSTRACT

The present invention relates to a method for transmitting and receiving a personal information, comprising the steps of: a communication terminal reads a personal information stored in respective information record device by electrically connecting the personal information card in which the personal information is recorded to a communication terminal or reciprocally contacting two communication terminals or electrically connecting the personal computer to the communication terminal; the communication terminal transmits the personal information data read from the information record device to a server by using the internet network; the server receives the personal information data and stores therein so as to provide various data and supplementary services to the communication terminal required therefrom.

### TECHNICAL FIELD

The present invention relates to a system for transmitting and receiving a personal information data, and more particularly, to a system for transmitting and receiving a personal information data, in which his/her own personal information data or other person's personal information data that is stored in a predetermined device is read out to use it as an electronic name card, and personal information data of several persons can be effectively managed by transmitting the personal information data, which is read out using an Internet network, to a designated server. Also, the present invention relates to a method for transmitting and receiving a personal information data using the system, in which a communication terminal transmits a personal information data, which is read out from a predetermined device, to a predetermined server to automatically classify the personal information data of other persons, and a communication terminal or a personal computer, each of which is connected to a predetermined server via an Internet network, searches a personal information data stored in the server, receives various data from the server, and transmits the user's request information to other communication terminal or the personal computer.

### BACKGROUND ART

Generally, a name card that records various information is widely used as public relations. The various information includes a company name or a corps name, a position in the company or the corps, a name, an address and phone numbers, and the like, is widely used as public relations.

However, since this kind of the name card is generally made out of a paper, it is easy to be torn apart and it is very troublesome for a certain person to classify the name cards every when the certain person receives the name cards from other persons.

Additionally, if a person wants to modify the personal information recorded in the name card, the person should discard the previous name card and make a new name card.

Since it is difficult to record a large amount of information in the name card, the person should use an additional printed matter or advertisement in order to introduce himself/herself or his/her company to other persons.

Furthermore, if the name card is lost, since there is no information on the other party, it is very difficult to contact the other party.

### DISCLOSURE OF THE INVENTION

Therefore, an object of the invention is to resolve the above problem and to transmit/receive the personal information data of the other party by contacting his/her own communication terminal, which stores the personal information such as a text document, a video and voice data, with the other party's communication terminal, or to connect the personal information card with the communication terminal to thereby read out the personal information data, or to electrically connect the personal information card with a personal computer to thereby receive the personal information data and offer a convenience to a user.

Another object of the invention is to store the personal information data of the other parities into a communication terminal and a server and to automatically classify the personal information data, thereby offering a convenience in editing the personal information data.

Further another object of the invention is to easily search the personal information data stored in a predetermined server using other communication terminals when his/her communication terminal storing the personal information of many persons is lost, and to download the searched personal information data to thereby re-store the lost personal information data into a new communication terminal.

To accomplish the above objects and advantages, the communication terminal and a predetermined server are connected to each other via an Internet network. The communication terminal transmits the personal information data that is read out from a personal information record medium and the various data to a server, and the server receives and stores the personal information data and the various data and provides the various data and supplement services that is requested from the communication terminal.

Hereinafter, system and method for transmitting and receiving the personal information data will be described with reference to FIGS. 1 to 10.

The personal information data is read out from an electronic name card by contacting the electronic name card with a wireless communication terminal. The other party's personal information data is received in a wireless communication method by reciprocally contacting two wireless communication terminals, or the wireless communication terminal receives the personal information data, which is stored in the personal computer, by electrically connecting the wireless communication terminal with the personal computer, and it selectively stores a necessary information among the received personal information data. The personal information data and the various data which are read out from the electronic name card, the wireless communication terminal and the personal computer are transmitted to the server and stored therein. Also, the personal information data stored in the server can be searched and the server provides the various data and the supplementary services.

### BRIEF DESCRIPTION OF THE DRAWINGS

The above object, other features and advantages of the present invention will become more apparent by describing the preferred embodiment thereof with reference to the accompanying drawings, in which:

FIG. 1 is a diagram showing a personal information card in accordance with the present invention;

FIG. 2 is a schematic diagram of a personal information record device for storing an information data into the personal information card in accordance with the present invention;

FIG. 3 is a block diagram showing the personal information record device in accordance with the present invention;

FIG. 4A is a perspective diagram showing the personal information card and a wireless communication terminal connected therewith;

FIG. 4B is a block diagram showing the personal information card and the wireless communication terminal connected therewith;

FIG. 5 is a perspective diagram showing an electrical connection of a wireless communication terminal and a personal computer;

FIG. 6 is a schematic diagram showing the wireless communication terminal and the personal computer;

FIG. 7 is a concept diagram showing a personal information transmission/reception system in accordance with the present invention;

FIG. 8 is a block diagram showing the personal information transmission/reception system shown in FIG. 7;

FIG. 9 is a flowchart showing sequential steps of transmitting information from a communication terminal to a server in accordance with the present invention; and

FIG. 10 is a flowchart showing a method for receiving information data transmitted from a communication terminal and transmitting information, which is requested from the communication terminal, to the communication terminal.

### BEST MODE FOR CARRYING OUT THE INVENTION

Now, preferred embodiments of the present invention will be described in detail with reference to the annexed drawings.

First Embodiment

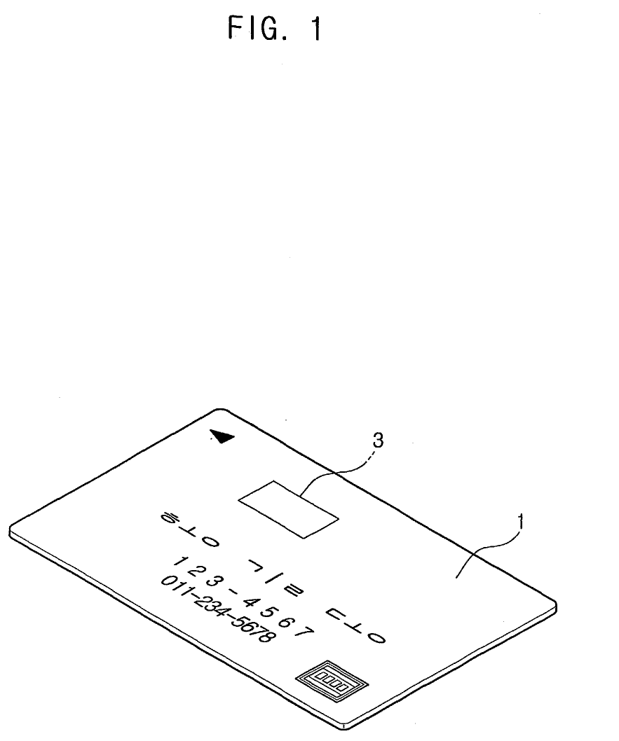

A structure of a wireless communication terminal for reading out a personal information data from a personal information card will be described with reference to FIGS. 1 to 4. Here, the personal information data includes a text document, a voice data, a video data, and the like.

For the sake of convenience in explanation, before explaining a wireless communication terminal in accordance with a first embodiment of the present invention, a personal information card for storing a personal information data and a personal information record device for recording an information data to the personal information card will be described.

FIG. 1 is a perspective diagram showing the personal information card 1. The personal information card 1 includes a memory for storing a text data, a video data and a voice data. The memory can be implemented with a magnetic tape (not shown) which is attached to a surface of the personal information card 1, or a semiconductor chip 3 which is installed within the personal information card 1.

In case of the semiconductor chip 3, a plurality of connection pads (not shown) for electrically connecting a device, such as a personal computer, a reading/writing device and a wireless communication terminal, with the semiconductor chip 3 are formed in an arrow direction in which the personal information card 1 is inserted.

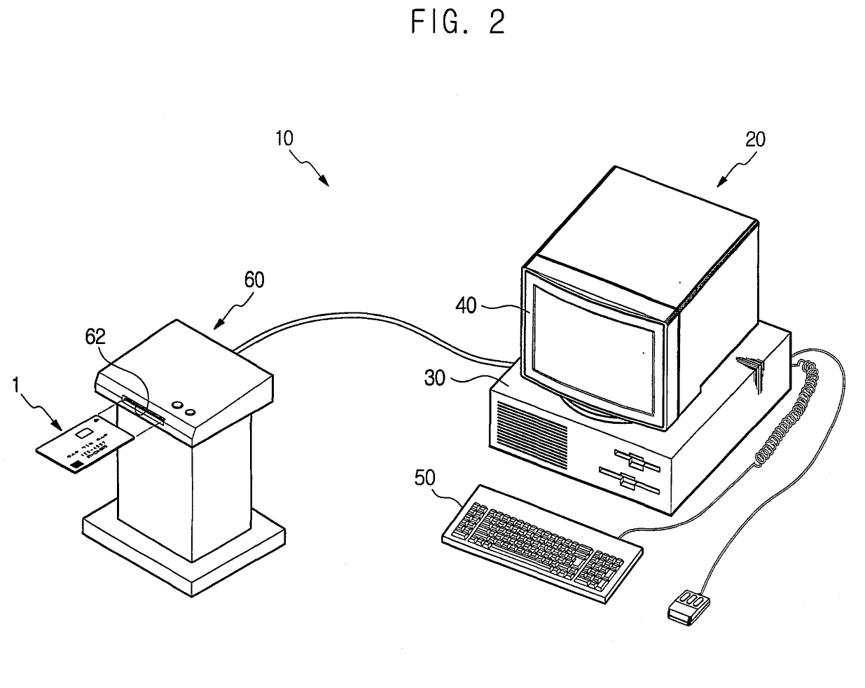

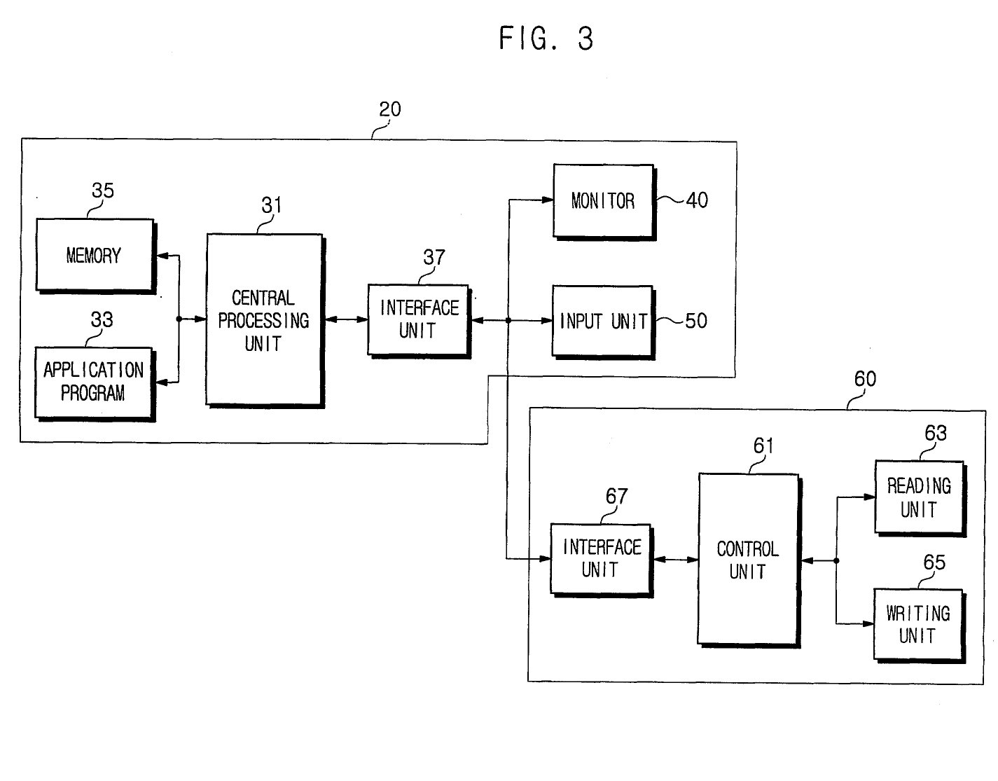

FIGS. 2 and 3 are a schematic diagram and a block diagram showing a personal information record device 10 for storing a personal information data into the personal information card 1 or modifying the personal information data stored in the personal information card. The personal information record device 10 includes a personal computer 20 for drawing up various personal information and a reading/writing device 60 for recording the personal information to the personal information card 1 or modifying the personal information data that is recorded in the personal information card 1.

The personal computer 20 includes a main body 30 for storing an application program required to draw up the personal information and transmitting the personal information to the reading/writing device 60, a monitor 40 for displaying the application program, and an input unit 50 for inputting the personal information according to the application program by a user.

As shown in FIG. 3, the main body 30 includes a central processing unit 31, an application program 33, a memory 35 and an interface unit 37. The central processing unit 31 controls the system entirely. The application program 33 records the personal information data in a text document, a video format and a voice format. The memory 35 stores the personal information data, which is processed according to a control of the central processing unit 31, and the application program 33. The interface unit 37 used as a port for connecting the main body 30 with the reading/writing device 60 transmits a file that is made in the application program to the reading/writing device 60 according to the control of the central processing unit 31.

Meanwhile, the reading/writing device 60 stores the personal information data transmitted from the personal computer 20 into the personal information card 1. The reading/writing device 60 includes an interface unit 67, a control unit 61, a reading unit. 63 and a writing unit 65.

The interface unit 67 that is connected with the interface unit 37 of the personal computer 20 via a cable receives the personal information data transmitted from the personal computer 20, and transmits the personal information data recorded in the personal information card 1 to the personal computer 20. The control unit 61 controls the reading/writing device 60 entirely. The writing unit 65 stores the personal information data transmitted from the personal computer 20 into the semiconductor chip 3 of the personal information card 1. The reading unit 63 reads the personal information data from the personal information card 1.

As shown in FIG. 2, a front face of the reading/writing device 60 includes an insertion slit 62 into which the personal information card 1 is inserted, and a plurality of connection pads (not shown), formed within the insertion slit 62, for electrically connecting the personal information card 1 and the reading/writing device 60.

A method for storing the personal information data into the personal information card using the personal information record device will be described below.

First, the application program 33 required to draw up the personal information is displayed on the monitor 40. Then, the user selects whether to newly draw up the personal information or to modify the personal information that is previously drawn up.

In case where the personal information is newly drawn up, the user types a self-introduction and the personal information in a text document according to the application program 33. Here, the personal information includes a name, a telephone number, a facsimile number, a company name, and the like.

Then, if the user wants to store the user's picture and motion image data, which introduces himself/herself to others, into the personal information card 1, the user inputs a video data into the personal computer 20 using a video information input device such as a scanner and a digital camera, or edits the video data that is previously stored in the personal computer 20 and then stores the edited video information.

Additionally, if the user wants to store the user's voice into the personal information card 1, the user inputs his/her voice into the personal computer 20 using a voice input device such as a microphone.

In case where the recording of the personal information data is completed according to instructions of the application program, the user checks whether or not there are contents to be modified. If there are the contents to be modified, the user returns an initial screen of the application program 33 and modifies necessary contents. If there are no contents to be modified, a message indicating to insert a new personal information card into the reading/writing device 60 is displayed on the monitor 40, wherein the new personal information card stores no information.

If the new personal information card is inserted into the reading/writing device 60, the central processing unit 31 transmits the personal information data stored in the memory 35 to the reading/writing device 60 via the interface unit 37.

Meanwhile, the interface unit 67 of the reading/writing device 60 receives the personal information data transmitted from the personal computer 20 and transmits the received personal information data to the writing unit 65 according to a control signal outputted from the control unit 61. Then, the writing unit 65 classifies the personal information data into a text data, a video data and a voice data, and then stores the classified personal information into respective memory areas contained in the semiconductor chip 3.

If the personal information data is stored into the personal information card 1 using the reading/writing device 60, the personal information card 1 comes out from the reading/writing device 60 through the insertion slit 62.

Second, a method for modifying the personal information data stored in the personal information card 1 will be described below.

The personal information card 1 storing the personal information data is inserted into the insertion slit 62 of the reading/writing device 60. Then, the reading unit 63 reads out the personal information data recorded in the personal information card 1, and transmits the read personal information data to the interface unit 67 contained in the reading/writing unit 60 according to the control signal. The interface unit 67 transmits the personal information data, which is transmitted from the reading unit 63, to the personal computer 20.

Meanwhile, the personal computer 20 that receives the personal information data transmitted from the reading/writing device 60 displays the text document and the video data on the monitor 40 and outputs a voice data through a speaker. If the user wants to modify the text document, the user returns to the initial screen of the application program 33 and deletes certain contents or types new contents. If the user wants to modify the video data and the voice data, the user inputs the video data and the voice data again, or edits the video data and the voice data stored in the personal computer 20.

If the modification of the personal information data is completed, the central processing unit 31 transmits the personal information data stored in the memory 35 to the reading/writing device 60 via the interface unit 37.

Meanwhile, the interface unit 67 of the reading/writing device 60 receives the personal information transmitted from the personal computer 20 and transmits the received personal information data to the writing unit 65 according to the control signal. outputted from the control unit 61. Then, the writing unit 65 classifies the personal information data into a text data, a video data and a voice data and stores the classified personal information data into respective memory areas contained in the semiconductor chip 3.

If the personal information data is stored into the personal information card 1 using the reading/writing device 60, the personal information card 1 comes out from the reading/writing device 60 through the insertion slit 62.

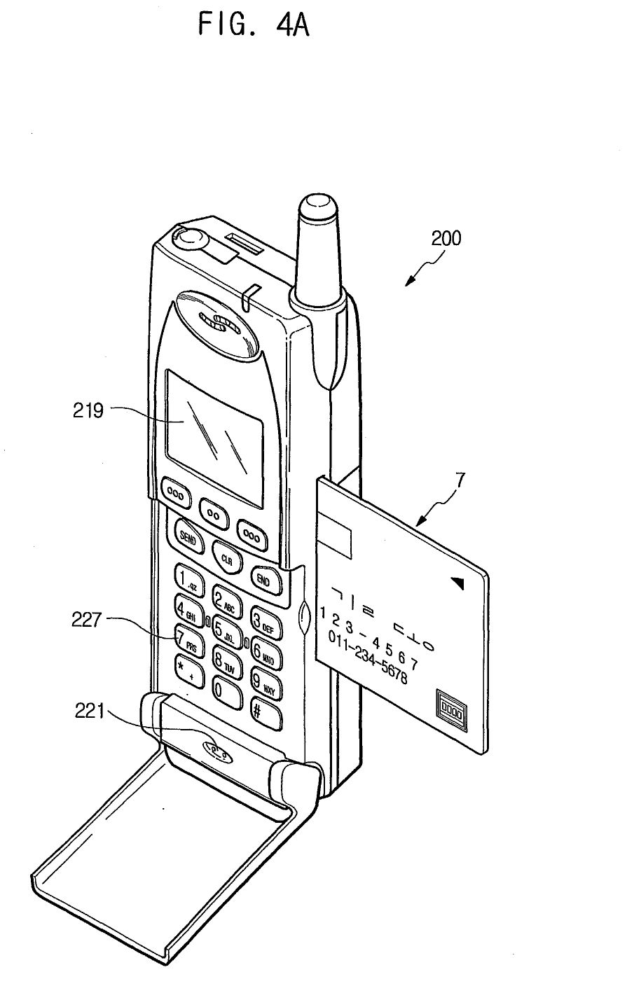

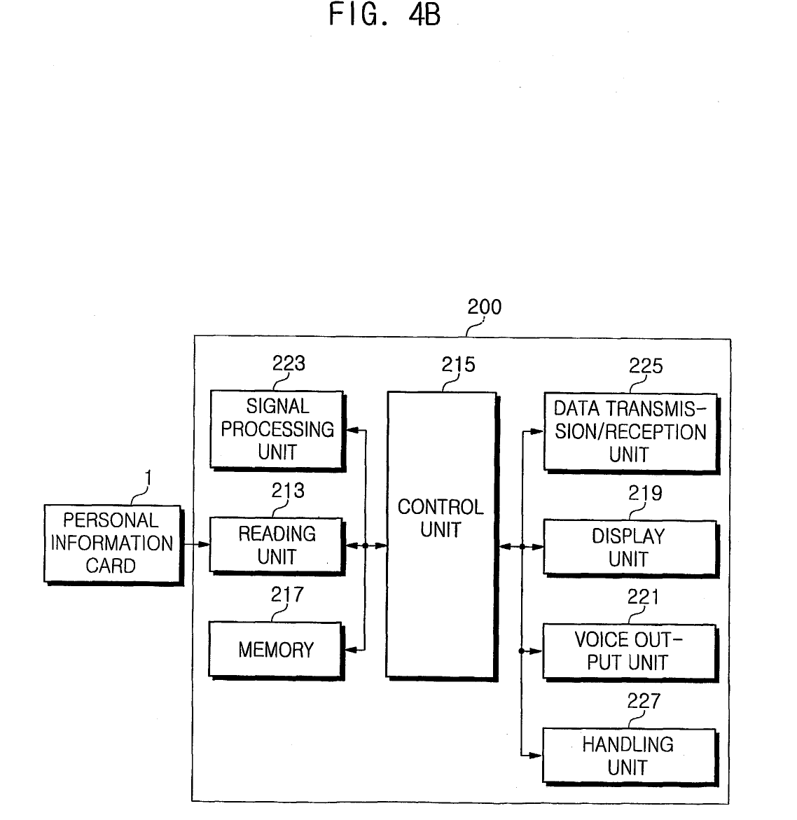

FIG. 4 is a perspective diagram showing the wireless communication terminal 200 for reading out the personal information from the personal information card 1 that stores the personal information.

Preferably, the wireless communication terminal 200 includes a slit and a plurality of connection pads (not shown). The slit is formed in one side of the wireless communication terminal 200, and the personal information card 1 is inserted into the slit. The connection pads are formed within the slit and are used to electrically connect the personal information card 1 with the wireless communication terminal 200. As mentioned above, the personal information data recorded in the personal information card 1 can be read out by inserting the personal information card 1 into the slit. Preferably, the personal information data can be read out in a wireless communication method by contacting the personal information card 1 with the wireless communication terminal 200.

Additionally, as shown in FIG. 4B, the wireless communication terminal 200 includes a reading unit 213, a control unit 215, a memory 217, information output units 219 and 227, a signal processing unit 223, a data transmission/reception unit 225 and a handling unit 227.

The reading unit 213 that is electrically connected with the connection pads reads out the personal information data stored in the personal information card 1. The control unit 215 controls the wireless communication terminal 200 entirely. The memory 217 stores temporarily the personal information data read out from the reading unit 213 according to a control signal. The information output units 219 and 227 outputs the personal information data read out from the reading unit 213 according to the control signal, thereby enabling the user to identify the personal information data. The signal processing unit 223 processes the personal information data read out from the reading unit 213 and a data transmitted from a wireless repeater server. The data transmission/reception unit 225 transmits the processed personal information data to the wireless repeater server or receives various data from a web server. The handling unit 227 inputs or/and searches information.

Here, when the personal information data that is temporarily stored in the memory 217 is transmitted to the wireless repeater server or by the user's handling, the rest of the personal information data except for a simple data, such as the name and the telephone number, are deleted.

The information output units include a display unit 219 for displaying a text data and a video data and a voice output unit 221 for outputting the voice data according to the control signal.

Second Embodiment

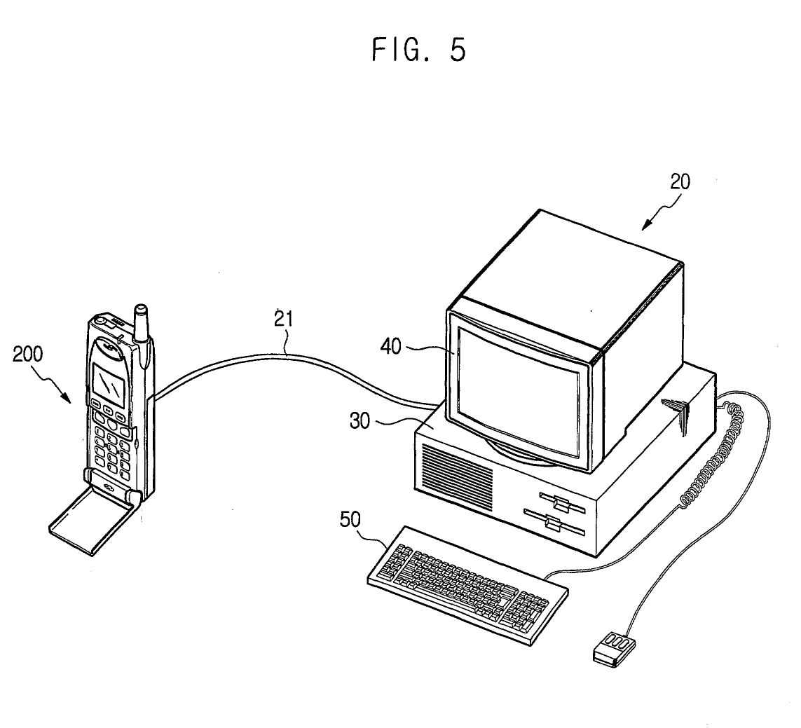

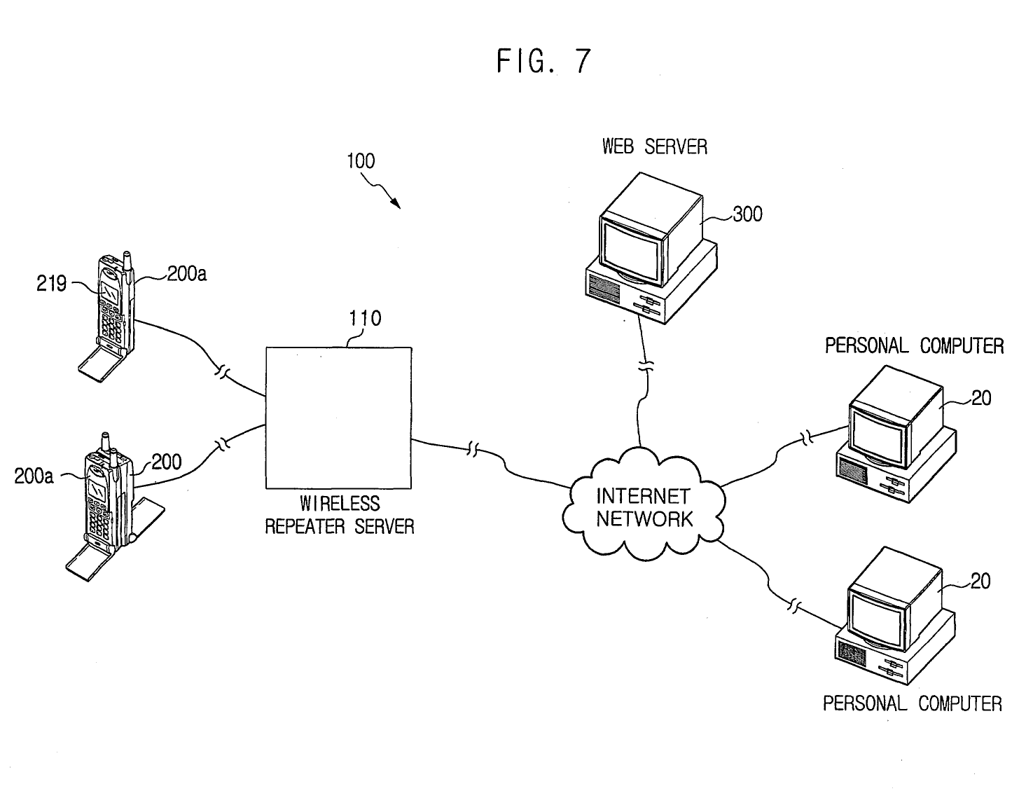

The wireless communication terminal 200 will be described with reference to FIGS. 5 to 8. The wireless communication terminal 200 downloads the personal information data from the personal computer 20 to transmit the downloaded personal information data, or reads the other party's personal information data by contacting the wireless communication terminal 200 with other wireless communication terminal 200a (shown in FIG. 7) or by adjacently placing the wireless communication terminal 200 and other wireless communication terminal 200a.

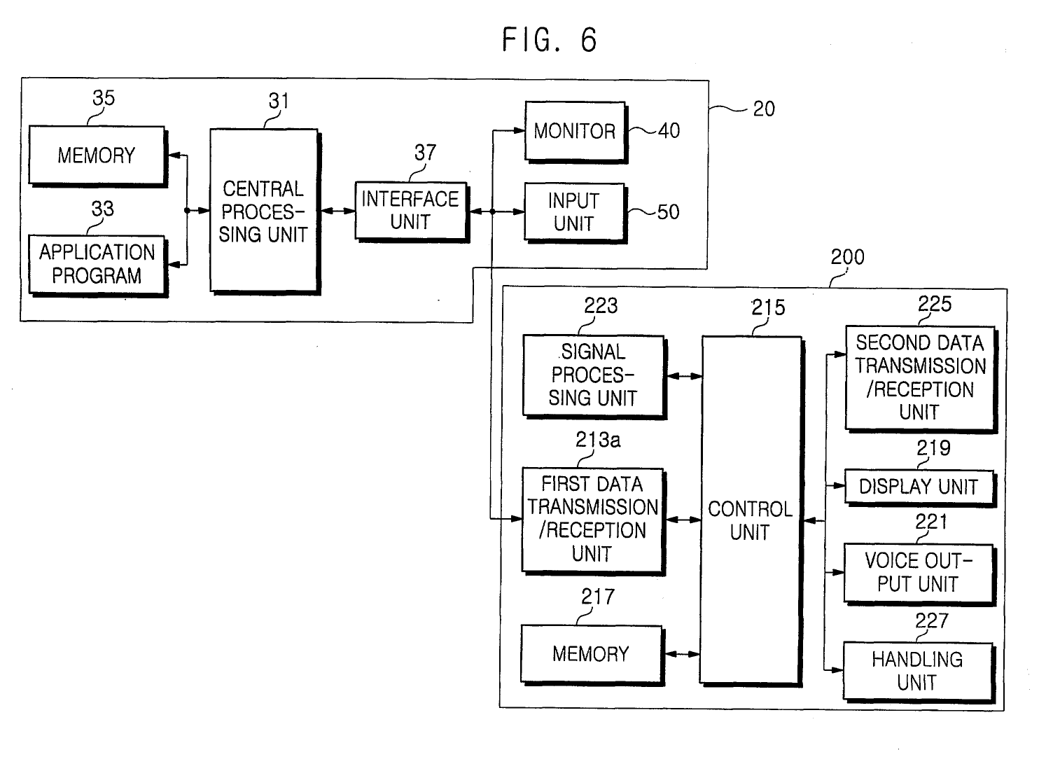

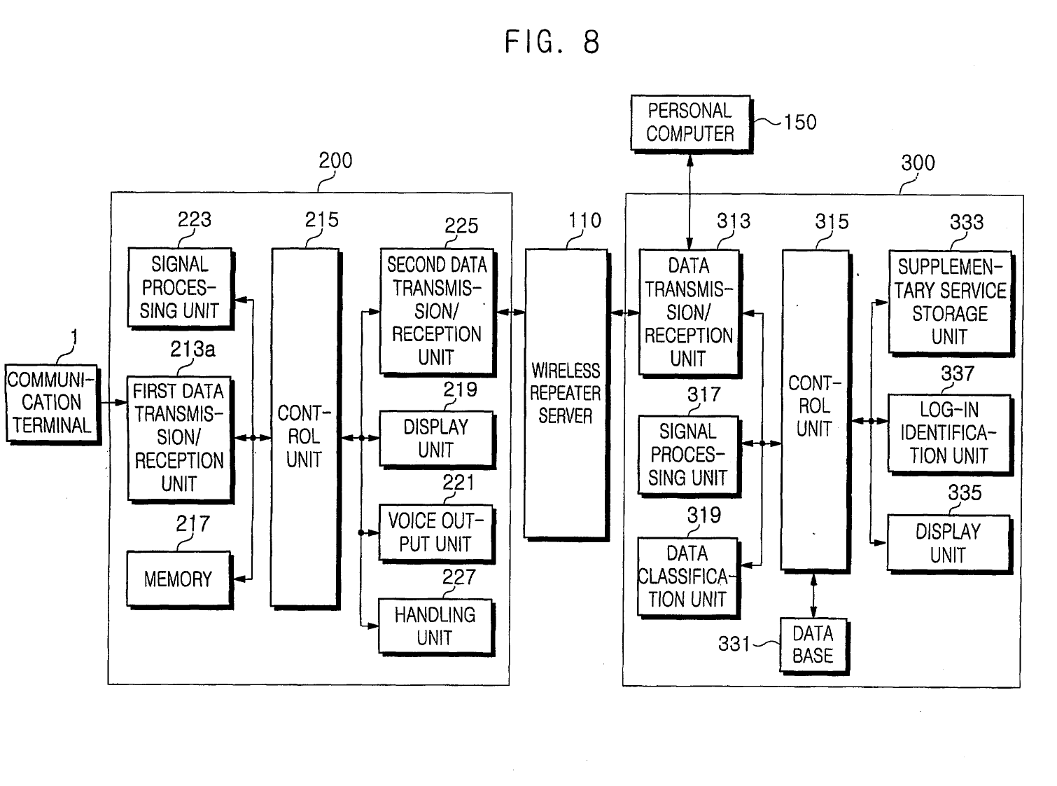

As shown in FIGS. 6 and 8, the wireless communication terminal 200 in accordance with the second embodiment of the present invention includes a first data transmission/reception unit 213a, a control unit 215, a memory 217, information output units 219 and 221, a signal processing unit 223, a second data transmission/reception unit 225and a handling unit 227.

The first data transmission/reception unit 213a reads out the personal information data when the wireless communication terminal 200 is adjacently placed to or contacted with the personal computer 20 or other wireless communication terminal 200a. The control unit 215 controls the wireless communication terminal 200 entirely. The memory 217 stores the personal information data read out from the first data transmission/reception unit 213a according to a signal outputted from the control unit 215. The information output units 219 and 221 outputs the personal information data read out from the first transmission/reception unit 213a according to the control signal. The signal processing unit 223 processes the personal information data read out from the first reading unit 213a and a data transmitted from a wireless repeater server. According to the control signal, the second data transmission/reception unit 225 transmits the processed personal information data to the wireless repeater server and receives various data from a web server. The handling unit 227 inputs or/and searches information.

Here, the information output units include a display unit 219 for displaying a text data and a video data and a voice output unit 221 for outputting the voice data according to a control signal.

A method for transmitting the personal information data drawn up in the personal computer 20 to the wireless communication terminal 200 will be described with reference to FIGS. 5 and 6.

Since the structure of the personal computer 20 and a method for making out the personal information are already described in the first embodiment of the present invention, the detailed descriptions thereof will be omitted.

The wireless communication terminal 200 is electrically connected to the personal computer 20 to thereby transmit the personal information data drawn up in the personal computer 20 to the wireless communication terminal 200 or transmit the personal information data stored in the wireless communication terminal 200 to the personal computer 20.

Preferably, as shown in FIG. 5, the wireless communication terminal 200 can be electrically connected to the personal computer 20 via a cable 21. Also, the wireless communication terminal 200 and the personal computer 20 can be electrically connected to each other by adjacently placing or contacting the wireless communication terminal 200 to or with the personal computer 20. At this time, the personal information data stored in the personal computer 20 is transmitted/received using a wireless communication method, i.e., an RF communication method or an infrared communication method.

If the wireless communication terminal 200 is electrically connected to the personal computer 20 via the cable 21, the personal information data stored in the memory 35 is transmitted to the first data transmission/reception unit 213a via the interface unit 37 according to a control of the central processing unit 31. If the personal information data is inputted to the first data transmission/reception unit 213a, the control unit 215 transmits the personal information data to the memory 217. Thereafter, the memory 217 classifies the personal information data into a text data, a video data and a voice data, and then stores the classified data into respective areas contained in the memory 217.

As described in the first and the second embodiments of the present invention, the wireless communication terminal 200 reads out the personal information data from the personal information card 1 or the personal computer 20, and transmits the personal information data to a predetermined server. A system 100 for transmitting and receiving an information will be described with reference to FIGS. 7 and 8, in which the wireless communication terminal 200 transmits the personal information data to the predetermined server and receives the information from the predetermined server.

Referring to FIG. 7, the system 100 in accordance with the present invention includes the wireless communication terminal 200, the wireless repeater server 110, the personal computer 20 and the web server 300, each of which is reciprocally connected to each other via an Internet network. The wireless communication terminal 200 reads out the personal information data from the personal information card 1, other wireless communication terminal 200a and the personal computer 20, and transmits various data including the personal information data to the wireless repeater server 110.

The wireless repeater server 110 receives the various data and transmits the received various data to the web server 300, or receives the various data transmitted from the web server and transmits the received various data to the wireless communication terminal 200. Also, the wireless repeater server 110 can store the. various data and provide the personal information data and the supplementary services through the wireless communication terminal 200.

Meanwhile, the web server 300 receives and stores the various data including the personal information transmitted from the wireless repeater server 110, and transmits an information, which is requested by the user, to the wireless communication terminal 200 or the personal computer 20.

As shown in FIG. 8, the web server 300 includes a data transmission/reception unit 313, a signal processing unit 317, a data classification unit 319, a database 331, a supplementary service storage unit 333, a display unit 335 and a log-in identification unit 337.

The data transmission/reception unit 313 connected to the wireless repeater server 110 via the Internet network receives the data transmitted from the wireless repeater server 100 and transmits the information, which is requested by the user, to the wireless communication terminal 200 and the personal computer 150. The control unit 315 controls the web server 300 entirely. The signal processing unit 317 processes the received data according to a control signal outputted from the control unit 315. The data classification unit 319 classifies the personal information data transmitted from the wireless repeater server 110 and other data into various kinds of data on the basis of field values. The database 331 stores the classified personal information data into corresponding groups. The supplementary service storage unit 333 stores various application programs for providing the various supplementary services, such as an electronic card service and an electronic album service, to the wireless communication terminal 200 and the personal computer 20. The display unit 335 displays the information data, and the log-in identification unit 337 identifies the user ID and password.

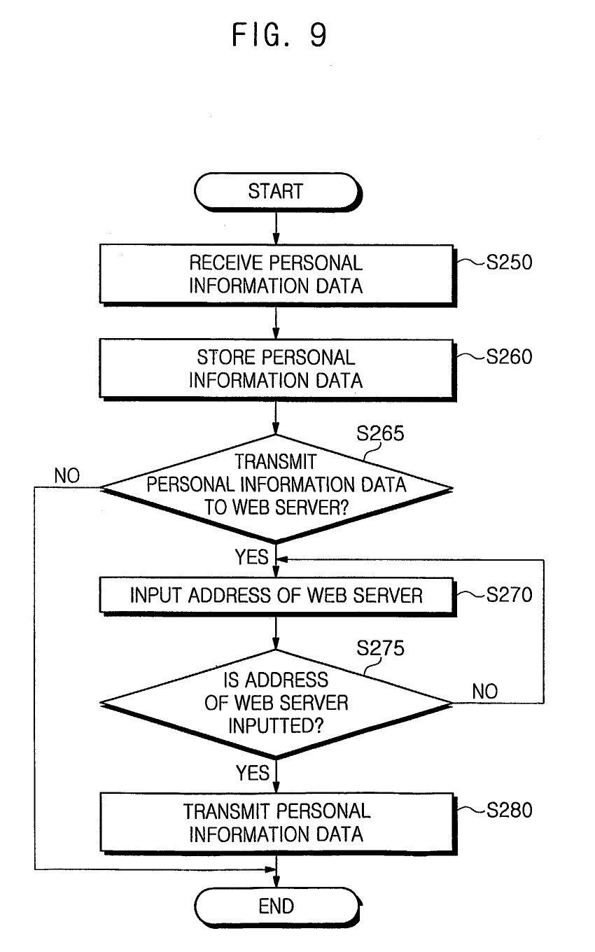

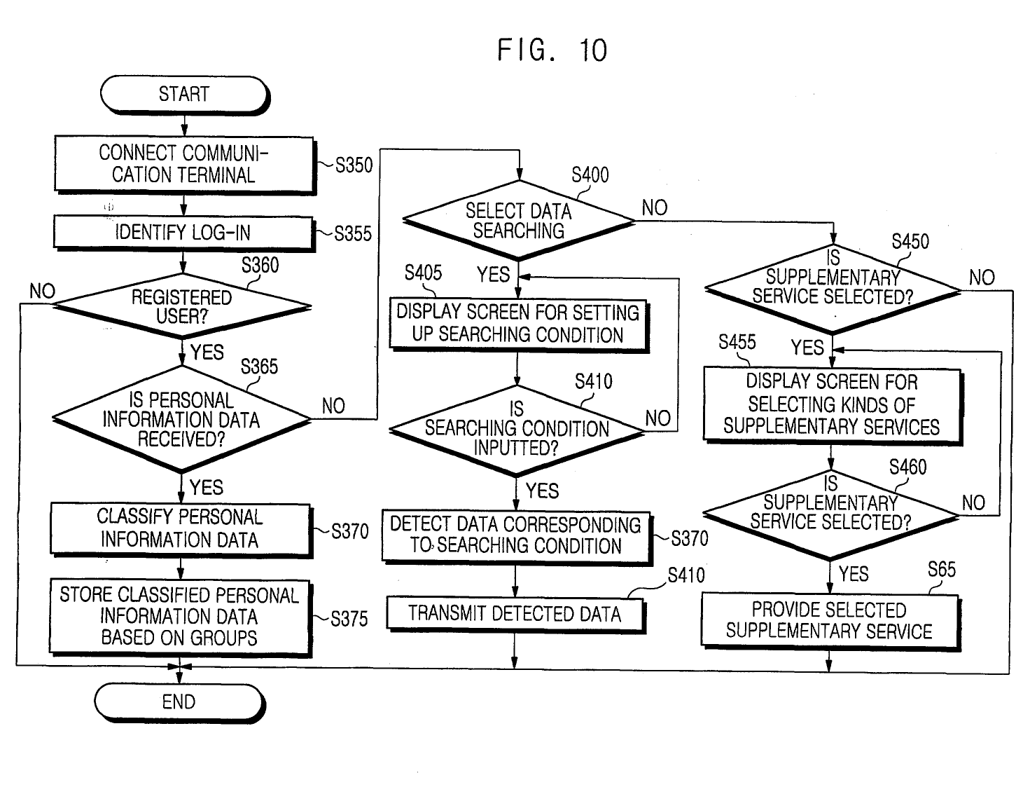

A method for transmitting and receiving a data in the system 100 in accordance with the present invention will be described with reference to FIGS. 7 to 10.

At step S250, the wireless communication terminal 200 is electrically connected to the other party's wireless communication terminal 200a by adjacently placing or contacting two communication terminals. Then, the user presses a hot key contained in the handling unit 227 to thereby transmit the personal information data to the wireless communication terminal 200 that requests the personal information data. Thereafter, the personal information data transmitted from the other party's wireless communication terminal 200a is inputted into the wireless communication terminal 200 through the wireless communication method. Here, the wireless communication method includes the infrared communication method and the RF communication method.

At step S260, the other party's personal information data, which is read out from the first data transmission/reception unit 213a, is temporarily stored in the memory 217 according to the control signal.

At step S265, the control unit 215 transmits the personal information data, which is read out from the first data transmission/reception unit 213a, to the display unit 219 and the voice output unit 221, respectively. Here, the display unit 219 displays the personal information data, which is transmitted from the control unit 215, in a form of identifiable information. Here, the personal information data includes the text data and the video data. The voice output unit 221 receives the voice data from the control unit 215 and outputs the received voice data to the outside of the wireless communication terminal 200.

Meanwhile, if the user of the wireless communication terminal 200 checks the personal information outputted through the display unit 219 and the voice output unit 221, and transmits a predetermined signal to the control unit 215 using the handling unit 227, the control unit 215 checks the predetermined signal.

At step S270, if it is checked that the predetermined signal is a signal indicating a transmission of the personal information data to the web server 300, the control unit 215 transmits the signal processed in the signal processing unit 223 to the second data transmission/reception unit 225. Then, the control unit 215 transmits a control signal to the display unit 219 to thereby display a screen capable of inputting the password and the address of the web server 300 which the user wants to connect to. The user inputs the password and the address of the web server 300 which the personal information data is to be transmitted to.

On the contrary, since the password and the address of the web server 300 are in advance set in the second data transmission/reception unit 225, the user can press the hot key in the handling unit 227 instead of directly inputting the address and the password to the wireless communication terminal 200.

At step S275, the control unit 215 checks whether the password and the address of the web server 300 are directly inputted by the user or inputted through the hot key.

At step S280, if it is checked that the password and the address of the web server 300 are inputted, the control unit 215 generates a control signal to the second data transmission/reception unit 225 to transmit the received personal information data to the wireless repeater server 110.

Additionally, when the personal information data that is temporarily stored in the memory 217 is transmitted to the wireless repeater server 110, the rest of the personal information data except for a simple data are deleted. This reason is because the wireless communication terminal 200 has a limited memory capacity. That is, if the data having a large size is stored in the memory 217, information on a few persons only can be stored.

Meanwhile, the wireless communication terminal 200 transmits the various data, such as a searching signal and a supplementary usage signal, as well as the personal information data, which is read out from the personal information card 1, to the web server 300, thereby obtaining a desired information from the web server 300. When the user wants to search the data stored in the web server 300 or to use the supplementary service without transmitting the personal information data to the web server 300, the password and the address of the web server 200 are inputted into the wireless communication terminal 200.

The wireless repeater server 110 transmits the various data including the personal information data, which is transmitted from the wireless communication terminal 200, to corresponding web server 300 through the Internet network.

At step S350, the wireless repeater server 110 is connected to the wireless communication terminal 200 and the web server 350 through the Internet network.

At step S355, the control unit 315 transmits a signal to the log-in identification unit 337 and checks whose is the ID and the password transmitted from the wireless communication terminal 200. Preferably, the ID is a telephone number of a motion-image telephone 200 used by the user.

At step S360, the control unit 315 checks whether or not the ID and the password are a registered user's.

At step S365, if it is checked that the ID and the password are the registered user's, the control unit 315 checks whether the personal information data is included among the data transmitted from the wireless communication terminal 200.

At step S370, if it is checked that the personal information data is included, the control unit 315 transmits the personal information data received from the second data transmission/reception unit 313 to the data classification unit 319. Then, the data classification unit 313 classifies the personal information data based on a name, a telephone number, a school from which one graduated and a company according to the data field value, and compares and searches the classified data. Then, the classified data is transmitted to the database 331 according to the control signal outputted from the control unit 315.

At step S375, the database 331 stores the classified data into corresponding groups, e.g., a same school, a colleague, an association of like-minded persons, and the like.

If the personal information data transmitted from the motion-image telephone 200 is classified and stored into the corresponding groups, the text document, the video data and the voice data can be transmitted to the users contained in an indicated group at the same time. For example, in case where a guidance letter of an alumni association is transmitted, if the alumni association group is selected, the guidance letter can be transmitted to all the classified alumni.

At step S400, it is checked that the personal information data is not included, the control unit 315 checks whether or not the data transmitted from the wireless communication terminal 200 includes a data searching signal.

At step S405, if it is checked that the personal information data includes the data searching signal, the control unit 315 transmits a screen for setting up a searching condition to the wireless communication terminal 200 to thereby display the screen on the display unit 219 thereof.

If the screen is displayed on the display unit 219, the user inputs a wanted group name through the handling unit 227. The user inputs a name and a telephone of a wanted person among the inputted group names and transmits them to the web server 300.

At step S410, the control unit 315 checks whether or not a predetermined searching condition is inputted.

At step S415, if the predetermined searching condition is inputted, the control unit 315 transmits a signal to the database 331 and the database 331 searches a data corresponding to the searching condition.

At step S420, the control unit 315 transmits the searched data to the wireless communication terminal 200.

Here, the case which the user wants to search the data is limited, e.g., when the user wants to modify or edit the contents stored in the web server 300, or when the user wants contents which is not stored in the wireless communication terminal 200, or when an information stored in the web server 300 is downloaded in case where the wireless communication terminal 200 storing the personal information data of several persons is lost.

At step S450, if it is checked that the data searching signal is not included, the control unit 315 checks whether or not the data transmitted from the wireless communication terminal includes a supplementary service usage signal.

At step S455, if it is checked that the data includes the supplementary service usage signal, the control unit 315 generates a signal to the supplementary service storage unit 333 to thereby transmit a screen for selecting the supplementary services to the wireless communication terminal 200.

If the screen for selecting the supplementary service is displayed on the display unit 219, the user clicks a wanted supplementary service among the various supplementary services.

At step 460, after transmitting the screen for selecting the supplementary service, the control unit 315 checks whether or not a predetermined supplementary service is selected.

At step S465, if it is checked that the predetermined supplementary service is selected, the control unit 315 transmits corresponding supplementary service to the wireless communication terminal.

Here, the supplementary services provided by the web server 300 includes a telephone number service, a facsimile transmission/reception service, an accounts management service, various electronic card services, a schedule management service and an alarm service as well as the electronic card service and the electronic album service.

For example, if the guidance letter of the alumni association is written after selecting the electronic card service among the supplementary services, the contents written in the electronic card are stored in the web server 300 and the alumni group is selected in the database 331. If a date when the guidance letter is written is earlier than a meeting date of the alumni, the user selects a reservation function and inputs a time, a data and a year when the user wants to transmit the guidance letter.

Then, the web server 300 transmits the electronic card containing the guidance letter to the wireless communication terminal or the personal computer of each person belonging to the alumni group.

Preferably, by installing the card reader in the personal computer 150, a wanted information data can be transmitted to the web server 300. Also, the contents stored in the web server 300 can be searched and the searched contents can be received.

Additionally, in case of the wireless communication terminal 200, the wireless repeater server 110 can perform an operation of the web server 300. At this time, since a method for transmitting and receiving the information between the wireless communication terminal 200 and the wireless repeater server 110 is equal to the method for transmitting and receiving the information between the web server 300 and the wireless communication terminal 200, a detailed description thereof will be omitted.

While the system and method for transmitting and receiving the personal information data have been described in detail with reference to the preferred embodiments, those skilled in the art will appreciate that various modifications and substitutions can be made thereto without departing from the spirit and scope of the present invention as set forth in the appended claims.

### Industrial Applicability

As described above, the present invention has the following advantages:

1. A large amount of information data can be stored using the personal information card with a built-in semiconductor chip having a large memory capacity. When the user wants to modify contents of the personal information data, the user can easily modify the contents recorded in the personal information card.

2. The communication terminal reads out the contents recorded in the personal information card, and a necessary information data is selectively stored into the communication terminal. The data designated by the user is transmitted to the server and the server stores a classified personal information data. Therefore, it is unnecessary to classify name cards separately, thereby offering a convenience.

3. When the communication terminal storing the personal information is lost, a necessary information data can be searched using other communication terminal and the necessary information data can be also downloaded, thereby restoring the lost personal information data easily.

1. A communication terminal comprising:
a control means for controlling a system entirely;
a personal information input means, wherein the personal information input means includes:
a slit, formed on a predetermined portion of an external housing of the personal information input means, which a personal information card storing a personal information data is inserted into;
a plurality of connection pads, formed in the slit, which are electrically connected with the personal information card; and
a reading unit, electrically connected with the connection pads, for reading the personal information data stored in the personal information card;
a memory for temporarily storing the personal information data which is read out form the reading means according to a control signal outputted from the control means;
an information output means for outputting the personal information data which is read out from the reading means in response to the control signal;
a data transmission/reception means for transmitting various data, which includes the personal information data, to an external device and receiving data transmitted from the external device according to the control signal; and
a handling means for inputting or/and searching information.

2. The communication terminal of claim 1, wherein the output means includes:
a display unit for displaying a text data and a video data; and
a voice output unit for outputting a voice data.

3. A communication terminal, comprising:
a control means for controlling a system entirely;
a first data transmission/reception means for reading out the other party's personal information data from an information record device through a wireless communication method, wherein the information record device stores the personal information data;
a memory for temporarily storing the personal information data which is read out form the first data transmission/reception means according to a control signal outputted from the control means;
an information output means for outputting the personal information data which is read out from the first data transmission/reception means according to the control signal;
a second data transmission/reception means for transmitting various data, which include the personal information data, to an external server and receiving data transmitted from the external server according to the control signal; and
a handling means for inputting or/and searching information.

4. The communication terminal of claim 3, wherein the wireless communication method is an infrared communication method for reading out the other party's personal information data by contacting the communication terminal with the information record device.

5. The communication terminal of claim 3, wherein the wireless communication method is an RF communication method for reading out the other party's personal information data by adjacently placing the communication terminal to the information record device.

6. A system for transmitting and receiving a personal information data, comprising:
a communication terminal for reading out a personal information data from an information record device to store the personal information data and transmitting various data which include the personal information data to an exterior; and
a server for receiving and storing the various data transmitted from the communication terminal and transmitting an information, which is requested from the communication terminal, to the communication terminal and a personal computer;
wherein the server includes:
a control means for controlling the system entirely;
a data transmission/reception means for receiving the various data, which include the personal information data transmitted from the communication terminal, and transmitting the information, which is requested from the communication terminal, to the communication terminal and the personal computer;
a database for storing the personal information data according to a control signal outputted from the control means;
a supplementary service storage means for storing various application programs which are needed to provide supplementary services requested from the communication terminal; and
a log-in identification means for identifying a user ID and a password.

7. The system of claim 6, wherein the communication terminal is a wireless communication terminal.

8. A method for transmitting and receiving a personal information data, comprising the steps of:
electrically connecting a communication terminal with an information record device, wherein the information record device stores a personal information data;
reading out the personal information data from the information record device to store the personal information data into a memory contained in the communication terminal, and transmitting various data, which include the personal information data, to a predetermined server through an Internet network;
receiving the various data transmitted from the communication terminal and identifying a log-in data in the received various data by the sever, and checking whether or not the log-in data is transmitted from a user who is registered to the server;
checking whether or not the personal information data is included among the various data, and, if it is checked that the personal information data is included among the various data, storing the personal information data into a database contained in the sever;
if it is checked that the personal information data is not included among the various data, checking whether or not a data searching signal is included among the various data, and, if it is checked that the data searching signal is included, transmitting a screen for setting up a searching condition to the communication terminal, and, if a predetermined searching condition is inputted from the communication terminal, searching a data corresponding to the searching condition and transmitting the searched data to the communication terminal;
if it is checked that the data searching signal is not included among the various data, checking whether or not a supplementary service selection signal is included among the various data, and, if it is checked that the supplementary service selection signal is included, transmitting a screen for selecting a supplementary service to the communication terminal, and checking whether a predetermined supplementary service is selected in the communication terminal and transmitting the selected supplementary service to the communication terminal.

9. The method of claim 8, wherein the step of transmitting the various data to the server is performed by pressing a hot key contained in a handling unit, an address of the server being in advance set in the hot key.

10. The method of claim 8, wherein, in the step of transmitting the various data to the server, when the various data is transmitted to the server, the server transmits a telephone number of the communication terminal together with an address of the server.

11. The method of claim 8, wherein, in the step of transmitting the various data including the personal information data to the server, only a simple personal information data is stored in the memory and the rest of the personal information data is deleted.

12. The method of claim 11, wherein, in the step of storing the personal information data, the personal information data is classified based on kinds, and the classified personal information data is stored into the database based on groups.
